(19) United States
(12) Patent Application Publication
(10) Pub. No.: US 2026/0046845 A1
(43) Pub. Date: Feb. 12, 2026

(54) ALLOCATION OF MULTIPLE ACCESS RESOURCES FOR COMMUNICATION DEVICES

(71) Applicant: Lenovo (Singapore) Pte Limited, Singapore (SG)

(72) Inventors: Robin Rajan THOMAS, Bad Nauheim (DE); Ali Ramadan ALI, Kraiburg am Inn (DE)

(21) Appl. No.: 18/797,366

(22) Filed: Aug. 7, 2024

(51) Int. Cl. H04W 72/044; H04W 72/23

(52) U.S. Cl. CPC H04W 72/044; H04W 72/23

(57) ABSTRACT

Various aspects of the present disclosure relate to physical layer enhancements for both transmitter devices (e.g., NEs) and receiver devices (e.g., UEs), such as enhancements to procedures and/or signaling during hybrid multiple access operations over networks supporting various radio access technologies. For example, the present disclosure introduces time-frequency domain resource allocation for hybrid MA, time domain resource allocation for hybrid MA, frequency domain allocation for hybrid MA, and spatial domain resource allocation for hybrid MA.

### TECHNICAL FIELD

The present disclosure relates to wireless communications, and more specifically to the allocation of multiple access resources for communication devices.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communication systems may support multiple access (MA), which may enable multiple user communication devices to simultaneous utilize a radio frequency spectrum. MA schemes include orthogonal MA (e.g., frequency division multiple access (FDMA), time division multiple access (TDMA)) and non-orthogonal MA (NOMA). NOMA may support wireless communications to multiple user communication devices within the same time-frequency resources using a power domain and/or a code domain.

An example of a NOMA technique includes rate split multiple access (RaSMA). According to RaSMA, a network communication device (e.g., a base station, network entity) may support splitting of messages, over non-orthogonally shared resources, into a common message stream transmitted to (and decoded by) each user communication device within a group of communication devices and private message streams transmitted to (and decoded by) specific user communication devices (e.g., devices for which the private messages are intended) within the group of devices. For example, a common message may comprise common components from messages transmitted to all user communication devices, and the private messages may comprise any remaining components not shared by all of the user communication devices. To retrieve a complete data message, a user communication device may decode the common message, including the corresponding private messages.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that facilitate allocation of multiple access resources for communication devices for hybrid multiple access schemes, such as both OMA and NOMA/RaSMA schemes.

Some implementations of the method and apparatuses described herein may further include a UE for wireless communication, comprising at least one memory and at least one processor coupled with the at least one memory and configured to cause the UE to receive, from a network entity, a configuration for resource allocation comprising a set of orthogonal time-frequency resources and a set of non-orthogonal time-frequency resources, determine a set of time-frequency resources for reception of user data, and de-map the determined set of time-frequency resources.

In some implementations of the method and apparatuses described herein, the at least one processor is configured to cause the UE to receive common user data messages based on the set of non-orthogonal time-frequency resources and in accordance with a hybrid multiple access scheme, and receive private user data messages based on the set of non-orthogonal time-frequency resources and in accordance with a hybrid multiple access scheme.

In some implementations of the method and apparatuses described herein, the determined set of time-frequency resources corresponds to a physical resource block (PRB) allocation level, a sub-PRB allocation level, a bandwidth part (BWP) allocation level, a carrier allocation level, or a combination thereof.

In some implementations of the method and apparatuses described herein, the UE is part of a group of UEs, and wherein the at least one processor is configured to cause the UE to perform OMA, NOMA, or RaSMA.

In some implementations of the method and apparatuses described herein, the resource allocation includes an OMA region and a NOMA region or RaSMA region, and wherein the OMA region and the NOMA region or RaSMA region are non-overlapping on a PRB level or a sub-PRB level, wherein each region is identified based at least in part on an identifier (ID).

In some implementations of the method and apparatuses described herein, the resource allocation comprises a first allocation of a contiguous set of PRBs for OMA within a configured carrier, and a second allocation of a contiguous set of PRBs for NOMA or RaSMA within the configured carrier.

In some implementations of the method and apparatuses described herein, the configuration comprises a bitmap associated with resource block groups for OMA-supported UEs and NOMA-supported UEs or RaSMA-supported UEs, wherein the resource block groups may be contiguous or non-contiguous.

In some implementations of the method and apparatuses described herein, the configuration indicates a division between OMA UEs and NOMA or RaSMA UEs in a spatial domain.

In some implementations of the method and apparatuses described herein, the resource allocation comprises a first allocation of a contiguous set of PRBs for OMA within a configured carrier and a second allocation of a contiguous set of PRBs for NOMA or RaSMA within the configured carrier.

In some implementations of the method and apparatuses described herein, the first allocation of the contiguous set of PRBs is associated with a first type of bandwidth part and the second allocation of the contiguous set of PRBs is associated with a second type of bandwidth part.

In some implementations of the method and apparatuses described herein, the first type of bandwidth part, the second type of bandwidth part, or both corresponds to a specific numerology or radio access technology.

In some implementations of the method and apparatuses described herein, the at least one processor is further configured to cause the UE to perform a downlink control information (DCI) decoding procedure comprising a first stage DCI that comprises hybrid multiple access information comprising at least a hybrid multiple access type indicator and a second stage DCI that comprises scheduling information for decoding either a OMA user data message or NOMA user data message or RaSMA user data message or other multiple access type user data message.

In some implementations of the method and apparatuses described herein, the at least one processor is configured to cause the UE to receive the configuration via downlink control information (DCI) signaling, radio resource control (RRC) signaling, medium access control (MAC) control element (CE) signaling, and combinations thereof.

Some implementations of the method and apparatuses described herein may further include a processor for wireless communication, comprising at least one controller coupled with the at least one memory and configured to cause the processor to receive, from a network entity, a configuration for resource allocation comprising a set of orthogonal time-frequency resources and a set of non-orthogonal time-frequency resources; determine a set of time-frequency resources for reception of user data, and de-map the determined set of time-frequency resources.

In some implementations of the method and apparatuses described herein, the at least one controller is configured to cause the processor to receive common user data messages based on the set of non-orthogonal time-frequency resources and in accordance with a hybrid multiple access scheme and receive private user data messages based on the set of non-orthogonal time-frequency resources and in accordance with a hybrid multiple access scheme.

In some implementations of the method and apparatuses described herein, the processor is part of a group of UEs, and wherein the at least one controller is configured to cause the processor to perform OMA, NOMA, or RaSMA.

Some implementations of the method and apparatuses described herein may further include a network entity for wireless communication, comprising at least one memory and at least one processor coupled with the at least one memory and configured to cause the network to determine a resource allocation for a group of user equipment (UEs) that perform OMA or NOMA or RaSMA, and transmit, to a UE, a configuration for resource allocation that comprises an orthogonal region of time-frequency resources and a non-orthogonal region of the time-frequency resources.

In some implementations of the method and apparatuses described herein, the at least one processor is configured to cause the network entity to transmit the configuration to the UE via control information signaling, RRC signaling, MAC CE signaling, and combinations thereof.

Some implementations of the method and apparatuses described herein may further include a method performed by a network entity, the method comprising determining a resource allocation for a group of UEs that perform OMA or NOMA or RaSMA, and transmitting, to a UE, a configuration for resource allocation that comprises an orthogonal region of time-frequency resources and a non-orthogonal region of the time-frequency resources.

In some implementations of the method and apparatuses described herein, transmitting the configuration includes transmitting the resource allocation configuration to the UE via control information signaling, RRC signaling, MAC CE signaling, and combinations thereof.

### BRIEF DESCRIPTION OF THE DRAWINGS

FIG. 1 illustrates an example of a wireless communications system in accordance with aspects of the present disclosure.

FIGS. 2A-2B illustrate example signaling between communication devices in accordance with aspects of the present disclosure.

FIG. 3 illustrates an example sub-PRB allocation for hybrid multiple access in accordance with aspects of the present disclosure.

FIG. 4A illustrates an example PRB allocation for hybrid multiple access in accordance with aspects of the present disclosure.

FIG. 4B illustrates a bandwidth part allocation for hybrid multiple access in accordance with aspects of the present disclosure.

FIG. 5 illustrates example bandwidth parts for hybrid multiple access in accordance with aspects of the present disclosure.

FIG. 6A illustrates an example scheduling for hybrid multiple access in accordance with aspects of the present disclosure.

FIG. 6B illustrates an example two stage decoding for hybrid multiple access in accordance with aspects of the present disclosure.

FIG. 6C illustrates resource block groups for hybrid multiple access in accordance with aspects of the present disclosure.

FIG. 7 illustrates hybrid multiple access with spatial components in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of a network equipment (NE) in accordance with aspects of the present disclosure.

FIG. 11 illustrates a flowchart of a method performed by a UE in accordance with aspects of the present disclosure.

FIG. 12 illustrates a flowchart of a method performed by an NE in accordance with aspects of the present disclosure.

### DETAILED DESCRIPTION

While a wireless communications system may implement a hybrid resource allocation scheme (e.g., OMA, NOMA, and/or RaSMA), issues can arise within a physical layer allocation framework, as conventional networks (e.g., NR and/or LTE) do not support the configuration of time-frequency resources for NOMA and/or RaSMA.

Thus, the wireless communications system may benefit from enabling devices (e.g., NEs or other transmitter devices) to schedule sets of time-frequency resources for hybrid MA based on network characteristics, such as the availability of resources, the number of user communication devices, channel link quality, and so on.

Further, because time-frequency resources are superpositioned, user communication devices employing RaSMA may benefit from a multi-stage control message decoding scheme, which can enable various devices to decode their respective control messages (e.g., both common and private messages under the RaSMA scheme) with a high degree of reliability.

The present disclosure describes physical layer enhancements for both transmitter devices (e.g., NEs) and receiver devices (e.g., UEs), such as enhancements to procedures and/or signaling during hybrid MA operations over networks supporting various radio access technologies. For example, the present disclosure introduces time-frequency domain resource allocation for hybrid MA, time domain resource allocation for hybrid MA, frequency domain allocation for hybrid MA, and spatial domain resource allocation for hybrid MA.

In doing so, a wireless communications system may efficiently and reliably deploy hybrid MA, such as RaSMA, across different networks, such as networks that support NR, LTE, or other radio access technologies.

Aspects of the present disclosure are described in the context of a wireless communications system.

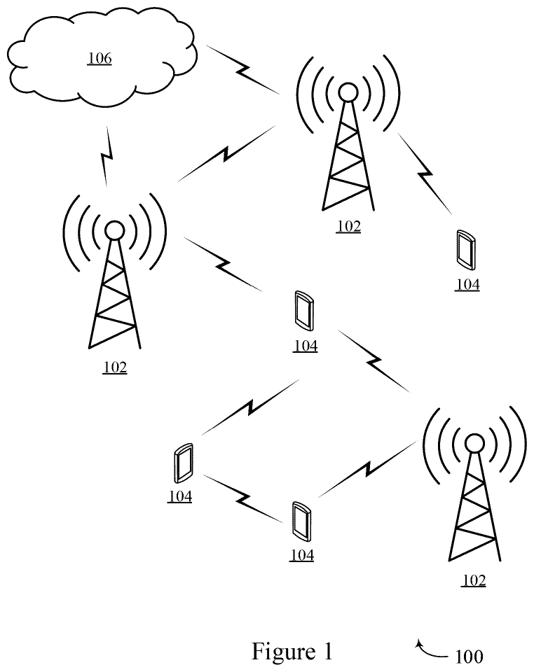

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHz-114.25 GHZ), FR4a or FR4-1 (52.6 GHz-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities. In some implementations, FR3 may be used by the NEs 102 and the UEs 104, among other equipment or devices, for cellular communications traffic (e.g., control information, data, and so on).

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the systems and methods may support hybrid multiple access schemes, such as RaSMA. RaSMA leverages the rate splitting (RS) of messages, such as transport blocks, and linear precoding in multi-antenna systems for multiple user communication devices within network communications systems.

RaSMA splits (and later re-combines) multiple user messages to form a common message, with remaining portions of the user messages forming private messages that are specific to each user. For example, the common message may be a message composed of a portion of K user messages, and the private messages may be a message composed on remaining portions of the K user messages.

The combined common message is encoded into one or more common streams and the private messages are separately encoded into private streams. The streams are precoded utilizing available channel state information at the transmitter (CSIT), whether it's perfect or imperfect. The streams are superimposed and transmitted using either multiple-input multiple-output (MIMO) or multiple-input single-output (MISO) broadcast channels (BC).

During reception of the streams, the receiving devices (e.g., a group of UEs) decode the common stream (or streams) and may apply successive interference cancellation (SIC) techniques to subtract the decoded common message stream from each of the devices received signals and then subsequently decode the respective private streams. Each UE deconstructs its original message by combining the portion embedded in the common streams with its specific private stream.

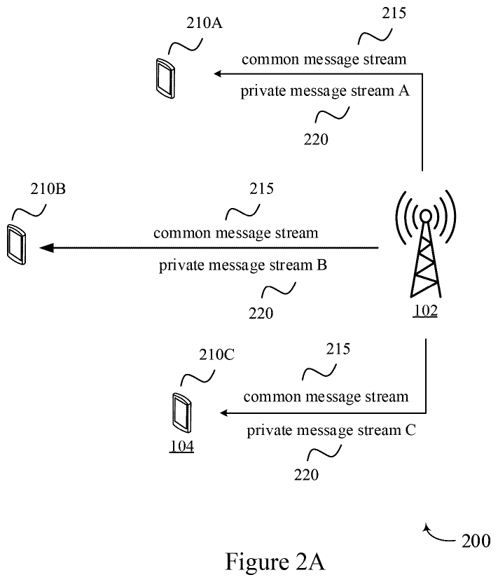

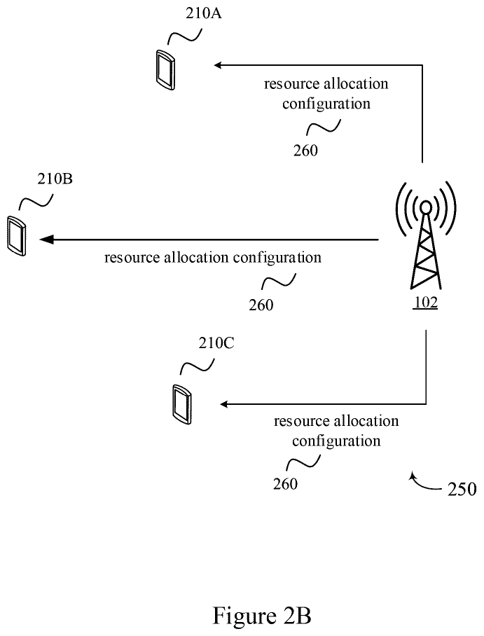

FIG. 2A illustrates example signaling 200 between communication devices in accordance with aspects of the present disclosure. The NE 102 transmits messages to a group of UEs 210A-C under a RaSMA scheme. For example, the NE 102 transmits a common message stream 215, as described herein, to all of the UEs 210A-C, and a private message stream 220 separately to each of the UEs 210A-C. Thus, UE 210A receives the common message stream 215 and a private message stream A, the UE 210B receives the common message stream 215 and a private message stream B, and the UE 210C receives the common message stream 215 and a private message stream C.

An example implementation is as follows: many users (e.g., users associated with the UEs 210A-C) are streaming a live event (e.g., a football match). The NE 102 transmits a video stream of the live event to all the users via a common message stream, and specific betting information to each of the users via a private message stream specific to the users.

The NE 102 may transmit a resource allocation configuration to the UEs 210A-C. FIG. 2B illustrates example signaling 250 between communication devices in accordance with aspects of the present disclosure. As shown, the NE 102 transmits a resource allocation configuration 260, which indicates to the UEs 210A-C the physical layer resources to allocate for both OMA and NOMA/RaSMA operations.

The resource allocation configuration 260 may indicate the allocation of resource to enable the UEs 210A-C to perform hybrid access of resources in both the orthogonal and the non-orthogonal manner. The resource allocation configuration 260 may indicate a physical later resource allocation framework for UEs (e.g., the UEs 210A-C) employing RaSMA to access time-frequency resources in a non-orthogonal manner. The framework may comprise various techniques for superimposing common messages and specific private messages on downlink channels in a hybrid manner.

In some embodiments, the NE 102 employs a sub-resource block allocation scheme. For example, using a given/configured PRB with

$${N}_{SC}^{PRB} = 12 ; {N}_{symbols}^{PRB} = 14 ,$$

a continuous resource element (RE) region within a PRB may be defined for OMA (e.g., represented as M continuous regions) and NOMA and/or RaSMA (e.g., represented as N continuous regions). M and N may be allocated using sub-scenarios, such as a equal proportion allocation or an unequal proportion allocation. In addition, each region (e.g., OMA, NOMA, and/or RaSMA) may be identified using an ID, such as a resource region ID. The resource region ID may be defined locally within a cell and/or on a semi-global manner across multiple cells, and may be signaled from the NE 102 to the UEs 104.

In some cases, equal proportion allocation is as follows:
Let

$${N}_{OMA - SC}^{PRB} and {N}_{OMA - symbols}^{PRB}$$

represent the number of subcarriers and symbols, respectively for the OMA region, where

$$M = {N}_{OMA - SC}^{PRB} \times {N}_{OMA - symbols}^{PRB}$$

resource elements;
Similarly, let

$${N}_{RaSMA - SC}^{PRB} and {N}_{RaSMA - symbols}^{PRB}$$

represent the number of subcarriers and symbols, respectively for the RaSMA (or NOMA) region, where

$$N = {N}_{RaSMA - SC}^{PRB} \times {N}_{RaSMA - symbols}^{PRB}$$

resource elements.

For example, if M=N, Let M₁=number of continuous REs in a M region, N₁=number of continuous REs in a N region, then

$${M}_{1} = {N}_{1} = \frac{{N}_{SC}^{PRB} \times {N}_{symbols}^{PRB}}{2} = 84 REs$$

for each M=1 and N=1 region. In some cases, if there are users orthogonally allocated then for an MOMA region in a PRB, then up to My users can be multiplexed. Similarly, if two users are a superpositioned subcarrier in the same RE, then up to 2×N₁ users may be allocated in the RaSMA/NOMA region.

In some cases, unequal proportion allocation is as follows:

When there are more resources available for allocation in the M=1 OMA region, in a 60:40 split of the PRB, then

$${M}_{1} = 0.6 \times ( {N}_{SC}^{PRB} \times {N}_{symbols}^{PRB} ) = 100 REs , and$$

$${N}_{1} = 0.4 \times ( {N}_{SC}^{PRB} \times {N}_{symbols}^{PRB} ) = 68 REs .$$

Such a scenario may depend on data quality of service (QoS) requirements, multi-user interference factors, and channel link conditions (e.g., when the link conditions are not suitable for RaSMA/NOMA, more sub-PRB resources (REs) may be allocated to the OMA region).

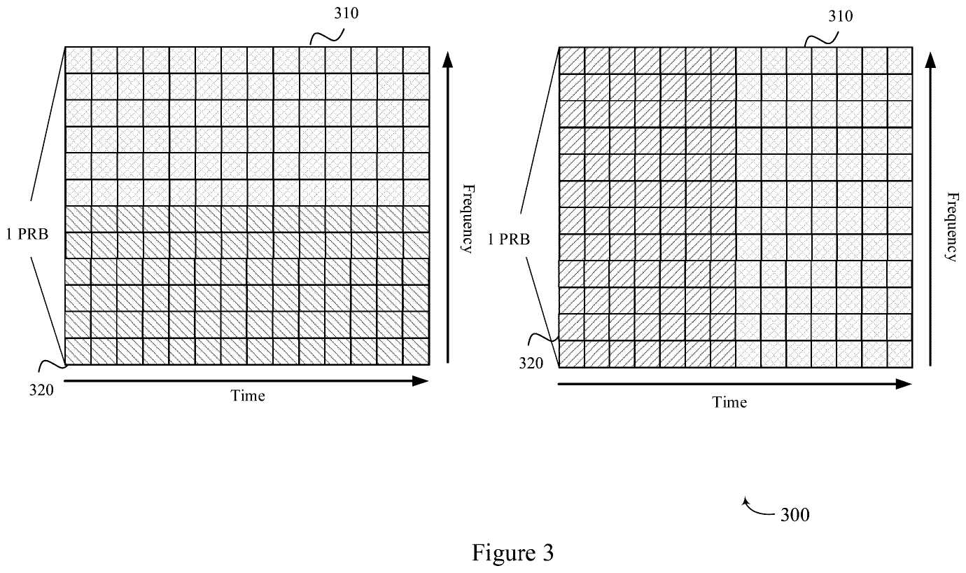

FIG. 3 illustrates an example sub-PRB allocation 300 for hybrid multiple access in accordance with aspects of the present disclosure. As shown, the M and N regions may support FDM or TDM, and, for simplicity of illustration, depicts a PRB for data (e.g., PDSCH) transmissions. For example, the sub-PRB allocation 300 includes an OMA region 310 and a RaSMA region 320.

In some cases, the allocation of sub-PRBs may include control symbols, such as RSs (e.g., DM-RS), and so on. Thus, the resource allocation may apply to transmission resources for control (e.g., PDCCH) and/or data information (e.g., PDSCH). Further, the resources may be allocated in a non-contiguous manner (e.g., an allocation of non-contiguous REs for OMA and for NOMA/RaSMA.

In some embodiments, the NE 102 employs a resource block allocation scheme (e.g., for different PRBs), where one or more PRBs are allocated for OMA and one or more different PRBs are allocated for NOMA/RaSMA.

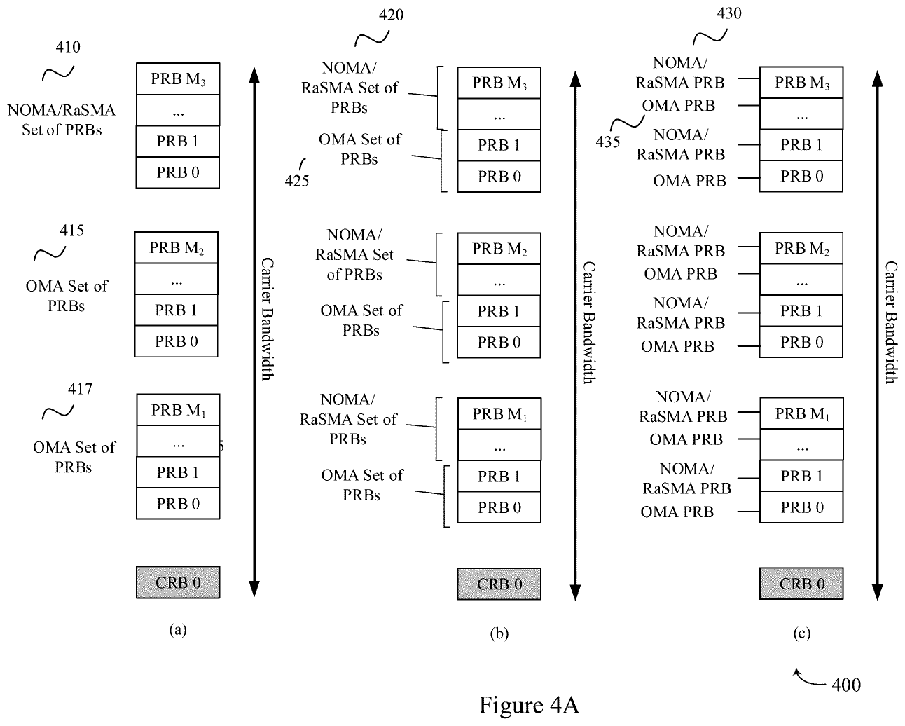

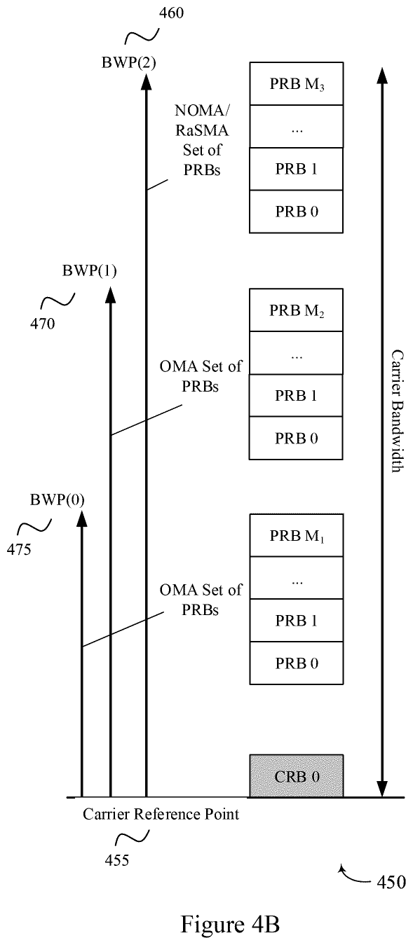

FIG. 4A illustrates an example PRB allocation 400 for hybrid multiple access in accordance with aspects of the present disclosure. For example, the PRB allocation (or partition) between OMA and NOMA/RaSMA may be implemented in various scenarios, such as scenarios A, B, and C.

In scenario A, a first set of contiguous PRBs 410 is allocated to NOMA/RaSMA, and subsequent sets contiguous PRB 415, 417 are allocated to OMA.

In scenario B, a set of PRBs includes a group (e.g., another set or subset) of PRBs 40 allocated to NOMA/RaSMA, and a group of PRBs 425 allocated to OMA.

In scenario C, a discontinuous (or non-contiguous) allocation of a PRB includes a PRB 430 for NOMA/RaSMA followed by a PRB 435 for OMA, and so on.

In the different scenarios, each PRB may be occupied by different groups of user communication devices (e.g., the UEs 210A-C), indicating that users allocated for orthogonal access may be allocated for hybrid MA (e.g., enabling a two-layer hierarchical RaSMA structure). In a two-layer hierarchical RaSMA structure, k users are divided into G non-overlapping groups of user, based on certain conditions. Assuming k users are divided into G non-overlapping groups, where S={1, 2, . . . , G}, the messages to be decoded by each user include a common message, a partial common message (e.g., according to each group), and a private message. This results in two layers of SIC decoding, where user ordering is not required, and the data streams of a high stream order are decoded before data streams of a lower stream order. Further, as described herein, the PRB allocation may be implemented for allocation of control information (e.g., PDCCH), and/or data information (e.g., PDSCH).

FIG. 4B illustrates a bandwidth part allocation 450 for hybrid multiple access in accordance with aspects of the present disclosure. As shown, PRBs may be allocated for each bandwidth part, with respect to a carrier reference part 455 (e.g., reference point A). For example, a BWP 460 is allocated to NOMA/RaSMA, and BWPs 470, 475 are allocated to OMA. Thus, each BWP may include a set of PRBs, where the BWP comprises a set of NOMA/RaSMA PRBs or a set of OMA PRBs.

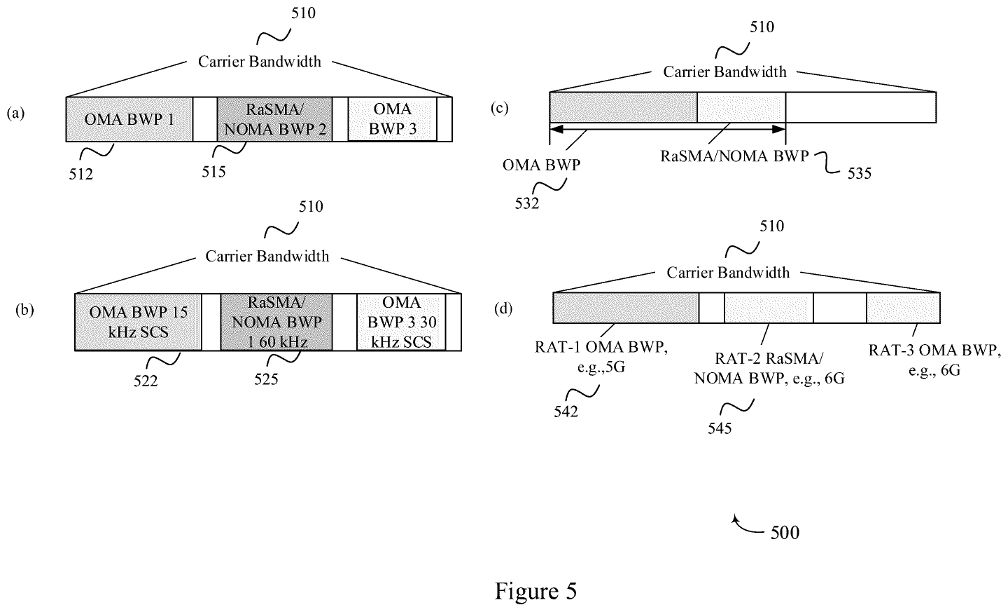

In some embodiments, the NE 102 employs a hybrid BWP allocation scheme for NOMA/RaSMA and OMA. FIG. 5 illustrates example bandwidth parts 500 for hybrid multiple access in accordance with aspects of the present disclosure. For example, the BWP allocation (or partition) between OMA and NOMA/RaSMA may be implemented in various scenarios, such as scenarios A, B, C, and D.

In scenario A, a carrier bandwidth 510 includes an OMA region 512 of time-frequency resources using a specific BWP (e.g., BWP1) and a NOMA/RaSMA region 515 uses a specific BWP (e.g., BWP2).

In scenario B, the carrier bandwidth 510 includes a subcarrier spacing (SCS) 522 for OMA (e.g., 15 kHz) and a SCS 525 for NOMA/RaSMA (e.g., 60 kHz). Example SCS may include 15 kHz, 30 kHz, 60 kHz, 120 kHz, 240 kHz, and so on.

In scenario C, the carrier bandwidth 510 includes an OMA BWP region 532 that overlaps with a NOMA/RaSMA region 535 (e.g., in order to avoid leakage, interference, and so on).

In scenario D, the carrier bandwidth 510 includes multiple BWPs across different RATs, such as a BWP 542 with RAT-1 (e.g., 5G) allocated to OMA and a BWP 545 with RAT-2 (e.g., 6G) allocated to NOMA/RaSMA.

As described herein, the BWOP allocation may be implemented for allocation of control information (e.g., PDCCH), and/or data information (e.g., PDSCH).

In some cases, an active BWP for an OMA region or a NOMA/RaSMA region may be activated for a given time and out of a given number of configured BWPs in a cell (e.g., 4 BWPs). The active BWP may also be activated for a given time in a cell-free implementation. Further, each BWP may be configured with an identifier (ID) associated with OMA or NOMA/RaSMA.

In some cases, while BWPs of different bandwidths may be configured depending on UE capabilities, the allocation and/or configuration may depend or be based on the available time-frequency resources. For example, in a high user density scenario, the system bandwidth may be stretched to maximum capacity, and RaSMA/NOMA may be allocated to smaller BWPs (in addition to larger BWPs).

In some embodiments, the NE 102 employs a hybrid carrier allocation scheme for OMA and NOMA/RaSMA. For example, an OMA region of time-frequency resources may be configured for a specific carrier, and a NOMA/RaSMA region may be configured for a different carrier.

In some cases, the allocation is supported for both uplink and downlink, and may be applied for the various MA schemes described herein. In some cases, carriers that employ a same MA scheme may be aggregated (e.g., to exploit high data rates) and, as described herein, may be implemented for allocation of control information (e.g., PDCCH), and/or data information (e.g., PDSCH).

In some embodiments, a resource allocation configuration (e.g., the resource allocation configuration 260) is transmitted (and received) via various communication or signaling techniques, including control information (e.g., PDCCH, DCI, and so on), RRC, DL MAC CE, and/or other higher layer signaling. Further, the various communication or signaling techniques may support switching between UEs.

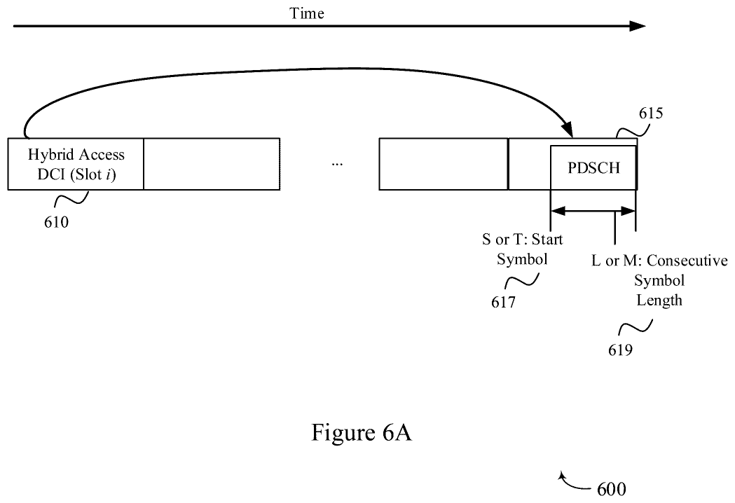

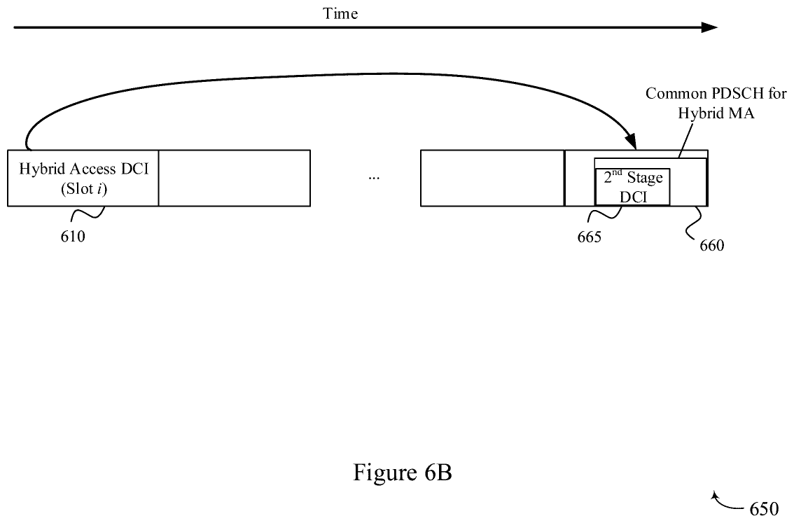

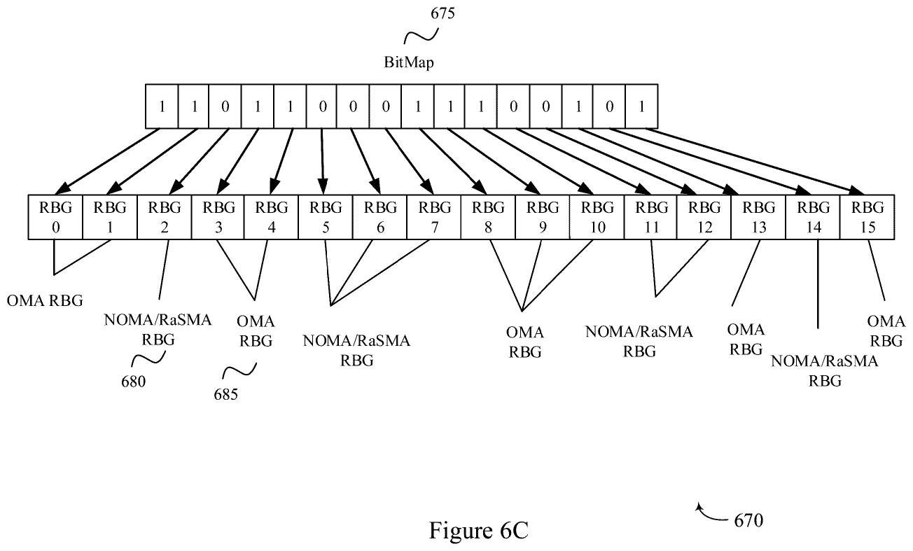

In some embodiments, a receiving device (e.g., the UE 104) may decode received control information to obtain/extract the resource allocation configuration and/or other scheduling information for user data transmission using hybrid MA schemes. FIG. 6A illustrates an example scheduling 600 for hybrid multiple access in accordance with aspects of the present disclosure.

For example, one or more UEs are scheduled to receive a hybrid MA DCI 610, which contains time-frequency scheduling information regarding the configured hybrid multiple access scheme. The one or more UEs may receive the DCI 610 (e.g., a DCI payload of bits including a set of cyclic redundancy check (CRC) bits scrambled by a hybrid MA specific radio network temporary identifier (RNTI)), which contains scheduling information about the hybrid MA resources. The DCI 610 may also contain additional information such as a start symbol and(S) 617 and consecutive symbol length (L) 619 for PDSCH orthogonal resources 615. In some cases, such as for NOMA/RaSMA, a new start symbol (e.g., T) and symbol consecutive length (M) may be defined.

The slot allocated for the PDSCH transmission may be determined by parameter K₀ of an indexed row i+K₀, where i is the slot with the scheduling DCI 610, and K₀ is based on the numerology of PDSCH. The starting symbol S or T (relative to the start of the slot), and the number of consecutive symbols L or M counting from the symbol S or T allocated for the PDSCH 615 are determined from the start and length indicator (e.g., Slot Length Indicator Value (SLIV)). The slot may be configured with the same or different numerology with respect to the numerology of the slot scheduled with the PDCCH. In some cases, time domain resource information may point to a row/index comprising the starting symbol, length of consecutive symbols, type of resource allocation scheme depending on the location of reference signal symbols in a slot and type of cyclic prefix, and so on.

In some cases, there may be multiple types of mapping for the hybrid MA on the PDSCH 615. The multiple types of mapping may enable certain permissible values for S/T or L/M as a function of the numerology and cyclic prefix length (e.g., normal or extended cyclic prefix). The hybrid multiple access PDSCH mapping type may be dependent on the 1) relative location of the demodulation reference signal (DM-RS) within a slot, 2) slot boundary 3) transport block size of the data to be transmitted, and other factors.

In some cases, a mapping type is when a first DM-RS is located at the beginning of the slot (e.g., in the first or second or third OFDM symbol of the slot) following a control information region of the slot (e.g., first few PDCCH symbols, CORESET (e.g., control region)) at the beginning of a slot. Thus, the DM-RS is mapped relative to the start of the slot boundary regardless of the start of data transmission in the slot (e.g., such as when user employing orthogonal MA or RaSMA/NOMA data occupies a significant portion of the slot).

In some cases, a mapping type is when the first DM-RS is located in the first symbol of the orthogonal MA or NOMA/RaSMA data allocation portion, indicating that the DM-RS location is not dependent on the relative slot boundary, but instead where the data is located. Such a mapping may be utilized for transmissions occupying a smaller portion of the slot, to support low latency data transmissions that cannot wait until a slot boundary starts, regardless of the transmission duration.

In some embodiments, depending on the type of user, a two-stage control information decoding may be employed to distinguish information for OMA users and NOMA/RaSMA users. FIG. 6B illustrates an example two stage decoding 650 for hybrid multiple access in accordance with aspects of the present disclosure.

The hybrid MA DCI may comprise common information 660 or information fields, depending on the RNTI used to scramble/descramble the CRC associated with the DCI message (e.g., a hybrid access RNTI). Such information may include scheduling information of a PDSCH, which comprises the 2^{nd} stage DCI 665 and common information for both OMA and RaSMA/NOMA/other MA users. In some cases, a separate RNTI may be employed for the 2^{nd} stage DCI, with respect to NOMA/RaSMA users, while a legacy C-RNTI or MCS-C-RNTI may be used to scramble/descramble the CRC associated with OMA users.

In some cases, the following common information may be transmitted via the hybrid MA DCI:
Hybrid Multiple Access Type Indicator-M bits e.g., (00—OMA, 01—RaSMA Multiple Access, 10—NOMA, 11—Other MA technique, xx-OMA/RasMA, xx-OMA/NOMA);
Frequency domain resource assignment of the

$$PDSCH - {log}_{2} ( {N}_{RB}^{BWP} ( {N}_{RB}^{BWP} + 1 ) / 2 ) ,$$

where

$${N}_{RB}^{BWP}$$

is the number of RBs per BWP;
Priority Information of Multiple Access Type: N bits of priority may represent N levels priority assigned to a certain type of Multiple access technique;
Modulation Coding Scheme (MCS) Scheme;
An additional MCS Table Indicator;
VRB-to-PRB Mapping;
Time Resource Assignment; and/or
2^{nd} Stage DCI Format as indicated in Table 1 below:

TABLE 1
Overview of 2^{nd} Stage DCI Formats for Hybrid MA

| 2^{nd} Stage DCI Value | 2^{nd} stage DCI Format |
|---|---|
| 00 | OMA Scheduling DCI Format, e.g., DCI |
| | Format for the scheduling of PDSCH in |
| | one DL cell (DCI Format 1_0), scheduling |
| | of one or multiple PDSCH in one cell (DCI |
| | Format 1_1), scheduling of PDSCH in one |
| | cell (DCI Format 1_2), scheduling of one |
| | PDSCH in one cell, or multiple PDSCHs in |
| | multiple cells with one PDSCH per cell |
| | (DCI Format 1_3), any other orthogonal |
| | scheduling DCI of PDSCH |
| 01 | RaSMA control information (DCI) |
| 10 | NOMA control information (DCI) |
| 11 | Other Multiple Access Type (DCI) |

In some cases, OMA information transmitted via the 2^{nd} stage DCI 665 includes:
Frequency domain resource assignment of the

$$OMA PDSCH - {log}_{2} ( {N}_{RB}^{BWP} ( {N}_{RB}^{BWP} + 1 ) / 2 ) ,$$

where

$${N}_{RB}^{BWP}$$

is the number of RBs per BWP;
Frequency Resource Allocation Type;
Time domain resource assignment—P bits;
Virtual Resource Block (VRB)-to-Physical Resource Block (PRB) mapping—Q bit;
Modulation and coding scheme—R bits;
New data indicator—1 bit;
Redundancy version—2 bits;
Hybrid automatic repeat request (HARQ) process number—A bits;
Downlink assignment index—B bits, as counter DAI;
TPC command for scheduled PUCCH—C bits;
PUCCH resource indicator—D bits;
PDSCH-to-HARQ_feedback timing indicator—E bits as defined; and so on.

In some cases, RaSMA information transmitted via the 2^{nd} stage DCI 665 (or, via one or more information elements in a separate DCI with a CRC scrambled within another RaSMA RNTI) includes:
Frequency domain resource assignment of the common message in the

$$PDSCH - {log}_{2} ( {N}_{RB}^{BWP} ( {N}_{RB}^{BWP} + 1 ) / 2 ) ,$$

where

$${N}_{RB}^{BWP}$$

is the number of RBs per BWP;
Frequency domain resource assignment of a UE's own private message scrambled with UE's C-RNTI;
Frequency Resource allocation Type;
Time domain resource assignment of the common message-P bits;
Virtual Resource Block (VRB)-to-Physical Resource Block (PRB) mapping common message and/or private message-Q bit;
Modulation and coding scheme common message and/or private message-R bits;
New data indicator common message and/or private message—1 bit;
Redundancy version common message and/or private message—2 bits;
HARQ process number common message and/or private message—A bits;
Downlink assignment index—B bits, as counter DAI;
TPC command for scheduled PUCCH—C bits;
PUCCH resource indicator—D bits;
PDSCH-to-HARQ_feedback timing indicator—E bits as defined; and so on.

In some cases, two sub-DCI formats may be defined under the RaSMA DCI, including a DCI, for the common message, with a CRC scrambled with RSC-RNTI, and, for the private message, with a CRC scrambled with RSP-RNTI. In such cases, the 2^{nd} stage DCI formats of Table 1 may be extended to include these additional sub-DCI formats or DCI formats.

In some cases, a time period K₁ may indicate a predefined time between the reception time of the end of an OMA or NOMA/RaSMA PDSCH and a start of a HARQ ACK/NACK transmission on the PUCCH. The K₁ value may depend on the numerology (e.g., SCS) and slot boundary, which in turn may depend on the PDSCH mapping type. The ACK/NACK may be further transmitted in response to a correctly or incorrectly received common message or private message, respectively.

In some embodiments, the receiving device, such as the UEs 210A-C, determine the hybrid MA frequency-domain resources upon which to transmit or receive data based on the physical resource allocation block configuration and applicable BWP/carrier indicator fields in the hybrid multiple access control information.

For example, the UEs 210A-C may determine the hybrid access frequency-domain resources via the resource-block allocation configuration in the control message (e.g., DCI). The resource allocation fields determine the resources blocks in the active BWP on which data is transmitted when only one BWP is active. The NE 102 (e.g., a base station, such as a gNB) may signal the resource allocation type to the UEs 210A-C, depending on the available resources and configured MA type.

In some cases, two different resource allocation types may be distinguished and supported for hybrid MA. For example, resource allocation Type 0 is a bitmap-based allocation scheme, which indicates a set of resource blocks via which the UE is to receive in the downlink transmission, where the size of the bitmap is equal to the number of PRBs in the active BWP. Type 0 enable various combination of resource blocks to be scheduled for the UE in a discontinuous manner across a BWP or carrier, where a “1” indicates the OMA or NOMA/RaSMA RBGs applicable to a UE.

In some cases, a combination of OMA and NOMA/RaSMA RBGs are signaled to a UE, where a bit value “1” indicates an OMA RBG and a bit value “0” indicates a NOMA/RaSMA RBG. FIG. 6C illustrates resource block groups 670 for hybrid multiple access in accordance with aspects of the present disclosure. As shown, a bitmap 675 indicates NOMA/RaSMA RBGs 680 via “0” values and OMA RBGs 685 via “1” values.

In some cases, the use of the bitmap 675 may realize a tradeoff for a size of the bitmap between overhead applied to associated resources and allocation flexibility of the resources, where the size of an RBG is a BWP size (in PRBs). For various BWP sizes, different configurations of RBGs may apply for both OMA and NOMA/RaSMA schemes, where an RBG may be defined for a specific MA scheme.

As another example, resource allocation Type 1 may indicate the allocated resources to the UE via a starting position and a length of the resource block allocation (e.g., supporting contiguous allocations in the frequency domain). In some cases, a resource indicator value (RIV) may also be supported to indicate the frequency domain resources in terms of start position and the length of resource allocation values. In other implementations, separate values for start position and resource allocation length may be signaled to the UE. The RIV or start value, in terms RB or RB length, may be associated with an OMA region and/or a NOMA/RaSMA region.

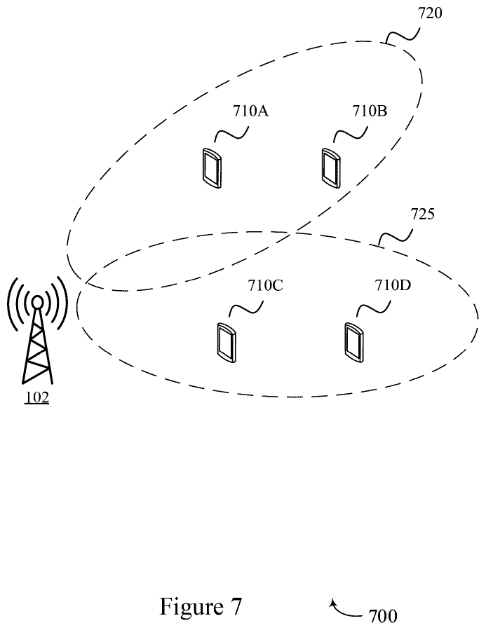

In some embodiments, a UE may determine the hybrid MA spatial domain resources via which it transmits or receives data based on the spatial domain configuration and related metrics in the hybrid multiple access control information. For example, a transmitter may direct one beam with orthogonal time-frequency resources to one or more users while directing another beam with non-orthogonal time-frequency resources (e.g., NOMA or RaSMA) to another group of users. FIG. 7 illustrates hybrid multiple access with spatial components 700 in accordance with aspects of the present disclosure.

A transmitter, such as a base station (e.g., the NE 102), transmits beams identified for resources allocated in a non-orthogonal manner or orthogonal manner, as described herein. For example, the transmitter (e.g., the NE 102), may transmit an OMA beam 720 for UEs 710A-B, which are associated with OMA, and a NOMA/RaSMA beam 725 for UEs 710C-D, which are associated with NOMA/RaSMA.

In some cases, the transmitter (e.g., the NE 102), utilizes reported beam measurements from the one or more UEs to determine which of the beams to utilize for OMA and/or NOMA/RaSMA. Example beam measurements may include: CSI-RS reference signal receiver power (RSRP)/received signal strength indicator (RSSI)/reference signal received quality (RSRQ), synchronization signal block (SSB) RSRP/RSSI/RSRQ, and/or other reference signal metrics.

Further, in some cases, the transmitter (e.g., the NE 102), performs various procedures for beam determination. For example, a first procedure may rely on no awareness from the UE as to which serving beams are suitable for the various multiple access procedures. The procedure may include transmitting wider beams (implying wider beamwidths) in all spatial directions (all angular space) to the UEs capable of supporting hybrid MA. In some cases, transmission of synchronization signals may be used to first establish the beams suitable for a particular MA technique.

As another example, a second procedure enhances the first procedure, where the transmitter may transmit narrower beams to the UEs depending on the configured multiple access technique. The narrower beams may originate from a single wider beam that was initially used (e.g., OMA may be used in the first procedure) and split up into multiple narrower beams in the second procedure, where the widths are allocated in an orthogonal or non-orthogonal fashion according to the number of served users.

As another example, the UE (e.g., the UE 104) utilizes Rx beam sweeping to assist in determining which of the beams are best suitable for a particular multiple access technique. The technique may utilize explicit feedback (e.g., based on UE measurements) to aid the transmitter in selecting a beam for a particular multiple access technique.

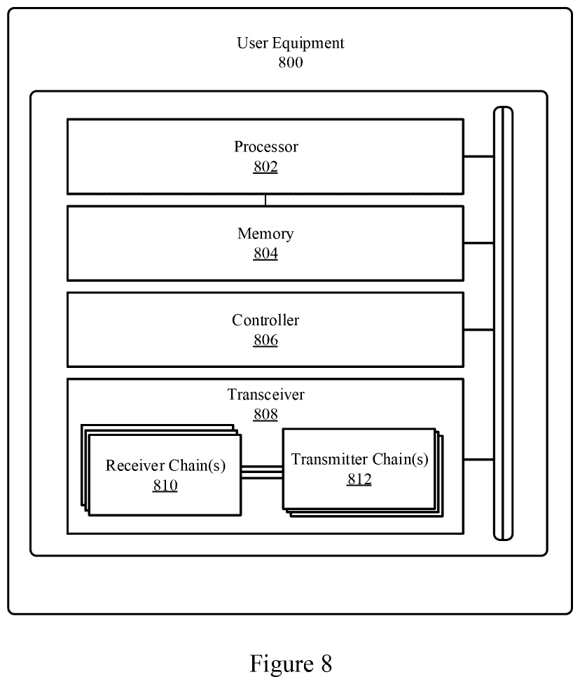

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to support a means for receiving, from a network entity, a configuration for resource allocation comprising a set of orthogonal time-frequency resources and a set of non-orthogonal time-frequency resources, determining a set of time-frequency resources for reception of user data, and de-mapping the determined set of time-frequency resources.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

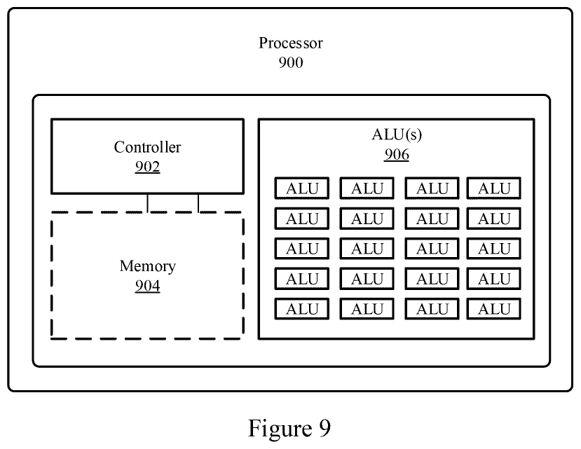

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The UE processor 900 may be configured to support a means for receiving, from a network entity, a configuration for resource allocation comprising a set of orthogonal time-frequency resources and a set of non-orthogonal time-frequency resources, determining a set of time-frequency resources for reception of user data, and de-mapping the determined set of time-frequency resources.

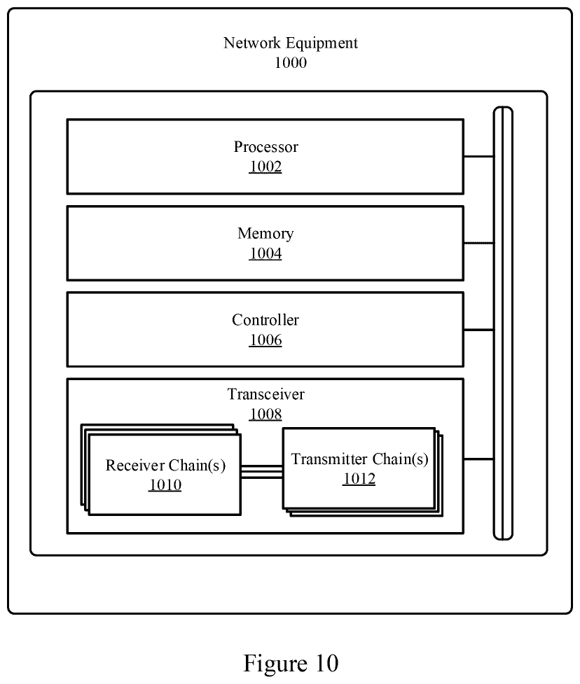

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to support a means for determining a resource allocation for a group of UEs that perform OMA or NOMA or RaSMA and transmitting, to a UE, a configuration for resource allocation that comprises an orthogonal region of time-frequency resources, and a non-orthogonal region of the time-frequency resources.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receive the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

As described herein, various implementations may include the UE 800 as a Tx node or Rx node, the processor 900 as the Tx node or Rx node, and/or the NE 1000 as the Tx node or Rx node.

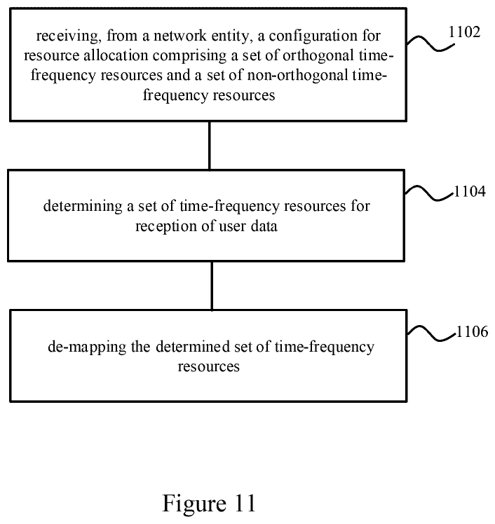

FIG. 11 illustrates a flowchart of a method in accordance with aspects of the present disclosure. The operations of the method may be implemented by a UE as described herein. In some implementations, the UE may execute a set of instructions to control the function elements of the UE to perform the described functions.

At 1102, the method may include receiving, from a network entity, a configuration for resource allocation comprising a set of orthogonal time-frequency resources and a set of non-orthogonal time-frequency resources. The operations of 1102 may be performed in accordance with examples as described herein. In some implementations, aspects of the operations of 1102 may be performed by a UE as described with reference to FIG. 8.

At 1104, the method may include determining a set of time-frequency resources for reception of user data. The operations of 1104 may be performed in accordance with examples as described herein. In some implementations, aspects of the operations of 1104 may be performed by a UE as described with reference to FIG. 8.

At 1106, the method may include and de-mapping the determined set of time-frequency resources. The operations of 1106 may be performed in accordance with examples as described herein. In some implementations, aspects of the operations of 1106 may be performed by a UE as described with reference to FIG. 8.

It should be noted that the method described herein describes a possible implementation, and that the operations and the steps may be rearranged or otherwise modified and that other implementations are possible.

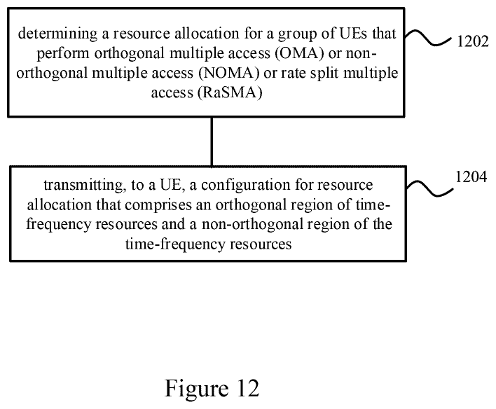

FIG. 12 illustrates a flowchart of a method in accordance with aspects of the present disclosure. The operations of the method may be implemented by an NE as described herein. In some implementations, the NE may execute a set of instructions to control the function elements of the NE to perform the described functions.

At 1202, the method may include determining a resource allocation for a group of UEs that perform OMA or NOMA or RaSMA. The operations of 1202 may be performed in accordance with examples as described herein. In some implementations, aspects of the operations of 1202 may be performed by an NE as described with reference to FIG. 10.

At 1204, the method may include transmitting, to a UE, a configuration for resource allocation that comprises an orthogonal region of time-frequency resources, and a non-orthogonal region of the time-frequency resources. The operations of 1204 may be performed in accordance with examples as described herein. In some implementations, aspects of the operations of 1204 may be performed by an NE as described with reference to FIG. 10.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a network entity, a configuration for resource allocation comprising a set of orthogonal time-frequency resources and a set of non-orthogonal time-frequency resources;
determine a set of time-frequency resources for reception of user data; and
de-map the determined set of time-frequency resources.

2. The UE of claim 1, wherein the at least one processor is configured to cause the UE to:
receive common user data messages based on the set of non-orthogonal time-frequency resources and in accordance with a hybrid multiple access scheme; and
receive private user data messages based on the set of non-orthogonal time-frequency resources and in accordance with a hybrid multiple access scheme.

3. The UE of claim 1, wherein the determined set of time-frequency resources corresponds to a physical resource block (PRB) allocation level, a sub-PRB allocation level, a bandwidth part (BWP) allocation level, a carrier allocation level, or a combination thereof.

4. The UE of claim 1, wherein the UE is part of a group of UEs, and wherein the at least one processor is configured to cause the UE to perform orthogonal multiple access (OMA), non-orthogonal multiple access (NOMA), or rate split multiple access (RaSMA).

5. The UE of claim 4, wherein the resource allocation includes an OMA region and a NOMA region or RaSMA region, and
wherein the OMA region and the NOMA region or RaSMA region are non-overlapping on a physical resource block (PRB) level or a sub-PRB level, wherein each region is identified based at least in part on an identifier (ID).

6. The UE of claim 4, wherein the resource allocation comprises:
a first allocation of a contiguous set of physical resource blocks (PRBs) for OMA within a configured carrier; and
a second allocation of a contiguous set of PRBs for NOMA or RaSMA within the configured carrier.

7. The UE of claim 4, wherein the configuration comprises a bitmap associated with resource block groups for OMA-supported UEs and NOMA-supported UEs or RaSMA-supported UEs, wherein the resource block groups may be contiguous or non-contiguous.

8. The UE of claim 4, wherein the configuration indicates a division between OMA UEs and NOMA or RaSMA UEs in a spatial domain.

9. The UE of claim 1, wherein the resource allocation comprises:
a first allocation of a contiguous set of physical resource blocks (PRBs) for OMA within a configured carrier; and
a second allocation of a contiguous set of PRBs for NOMA or RaSMA within the configured carrier.

10. The UE of claim 9, wherein:
the first allocation of the contiguous set of PRBs is associated with a first type of bandwidth part; and
the second allocation of the contiguous set of PRBs is associated with a second type of bandwidth part.

11. The UE of claim 10, wherein the first type of bandwidth part, the second type of bandwidth part, or both corresponds to a specific numerology or radio access technology.

12. The UE of claim 1, wherein the at least one processor is further configured to cause the UE to:
perform a downlink control information (DCI) decoding procedure comprising:
first stage DCI that comprises hybrid multiple access information comprising at least a hybrid multiple access type indicator, and
a second stage DCI that comprises scheduling information for decoding either a OMA user data message or NOMA user data message or RaSMA user data message or other multiple access type user data message.

13. The UE of claim 1, wherein the at least one processor is configured to cause the UE to:
receive the configuration via downlink control information (DCI) signaling, radio resource control (RRC) signaling, medium access control (MAC) control element (CE) signaling, and combinations thereof.

14. A processor for wireless communication, comprising:
at least one controller coupled with the at least one memory and configured to cause the processor to:
receive, from a network entity, a configuration for resource allocation comprising a set of orthogonal time-frequency resources and a set of non-orthogonal time-frequency resources;
determine a set of time-frequency resources for reception of user data; and
de-map the determined set of time-frequency resources.

15. The processor of claim 14, wherein the at least one controller is configured to cause the processor to:
receive common user data messages based on the set of non-orthogonal time-frequency resources and in accordance with a hybrid multiple access scheme; and
receive private user data messages based on the set of non-orthogonal time-frequency resources and in accordance with a hybrid multiple access scheme.

16. The processor of claim 14, wherein the processor is part of a group of UEs, and wherein the at least one controller is configured to cause the processor to perform orthogonal multiple access (OMA), non-orthogonal multiple access (NOMA), or rate split multiple access (RaSMA).

17. A network entity for wireless communication, comprising:
at least one memory; and
at least one processor coupled with the at least one memory and configured to cause the network to:
determine a resource allocation for a group of user equipment (UEs) that perform orthogonal multiple access (OMA) or non-orthogonal multiple access (NOMA) or rate split multiple access (RaSMA); and
transmit, to a UE, a configuration for resource allocation that comprises:
an orthogonal region of time-frequency resources; and
a non-orthogonal region of the time-frequency resources.

18. The network entity of claim 17, wherein the at least one processor is configured to cause the network entity to transmit the configuration to the UE via control information signaling, radio resource control (RRC) signaling, medium access control (MAC) control element (CE) signaling, and combinations thereof.

19. A method performed by a network entity, the method comprising:
determining a resource allocation for a group of user equipment (UEs) that perform orthogonal multiple access (OMA) or non-orthogonal multiple access (NOMA) or rate split multiple access (RaSMA); and
transmitting, to a UE, a configuration for resource allocation that comprises:
an orthogonal region of time-frequency resources; and
a non-orthogonal region of the time-frequency resources.

20. The method of claim 19, wherein transmitting the configuration includes transmitting the resource allocation configuration to the UE via control information signaling, radio resource control (RRC) signaling, medium access control (MAC) control element (CE) signaling, and combinations thereof.
